(19) United States
(12) Patent Application Publication
(10) Pub. No.: US 2014/0377437 A1
(43) Pub. Date: Dec. 25, 2014

(54) System and Method for Printing on a Food Item

(71) Applicant: Desilva Daniel Singleton, Houston, TX (US)

(72) Inventor: Desilva Daniel Singleton, Houston, TX (US)

(21) Appl. No.: 13/921,225

(22) Filed: Jun. 19, 2013

(51) Int. Cl. A23P 1/08; A23G 3/34; A23L 1/164; A21D 13/00; A23L 1/00

(52) U.S. Cl. CPC A23P 1/086; A21D 13/0009; A23L 1/0067; A23L 1/1641; A23G 3/0089; A23P 2001/089
USPC 426/549; 426/383; 426/531; 426/620; 426/658; 426/661

(57) ABSTRACT

A system and method for printing on a food item is disclosed herein. In one embodiment, a system for printing on a food item can comprise a food item, one or more edible sheets, and an edible adhesive. The edible sheet can be printable with a design. The edible adhesive can attach the edible sheet onto the food item. In another embodiment, a method for printing on a food item can comprise the steps printing a design on a surface of an edible sheet, and connecting the edible sheet to one or more surfaces of a food item using an edible adhesive.

### BACKGROUND

This disclosure relates to a system and method for printing on a food item.

Methods for decorating baked goods such as cakes, and cookies have evolved over the years. Today, one of the easiest and popular ways of customizing and decorating confectioners is through edible frosting or icing prints. Frosting prints is the process of reproducing or creating text and/or images using edible ink on different baked goods. However, over the years frosting prints has not been put on granola bars and are only made possible for baked goods having smooth surfaces such as cakes, cookies, and some pastries. As such, it would be useful to have an improved system and method for printing on a food item.

### SUMMARY

A system and method for printing on a food item is disclosed herein. In one embodiment, a system for printing on a food item can comprise a food item, one or more edible sheets, and an edible adhesive. The edible sheet can be printable with a design. The edible adhesive can attach the edible sheet onto the food item.

In another embodiment, a method for printing on a food item can comprise the steps printing a design on a surface of an edible sheet, and connecting edible sheet on one or more surfaces of a food item using an edible adhesive.

### BRIEF DESCRIPTION OF THE DRAWINGS

FIG. 1 illustrates an edible printable sheet printed with ink and placed on a food item.

FIG. 2 illustrates how a sheet can be attached on a food item through an adhesive.

FIG. 3A illustrates a food item with pictures printed.

FIG. 3B illustrates a food item with small text printed.

FIG. 4A illustrates another food item with a mounted printable sheet

FIG. 4B illustrates another food item with a mounted printable sheet.

### DETAILED DESCRIPTION

Described herein is a system and method for printing on a food item. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

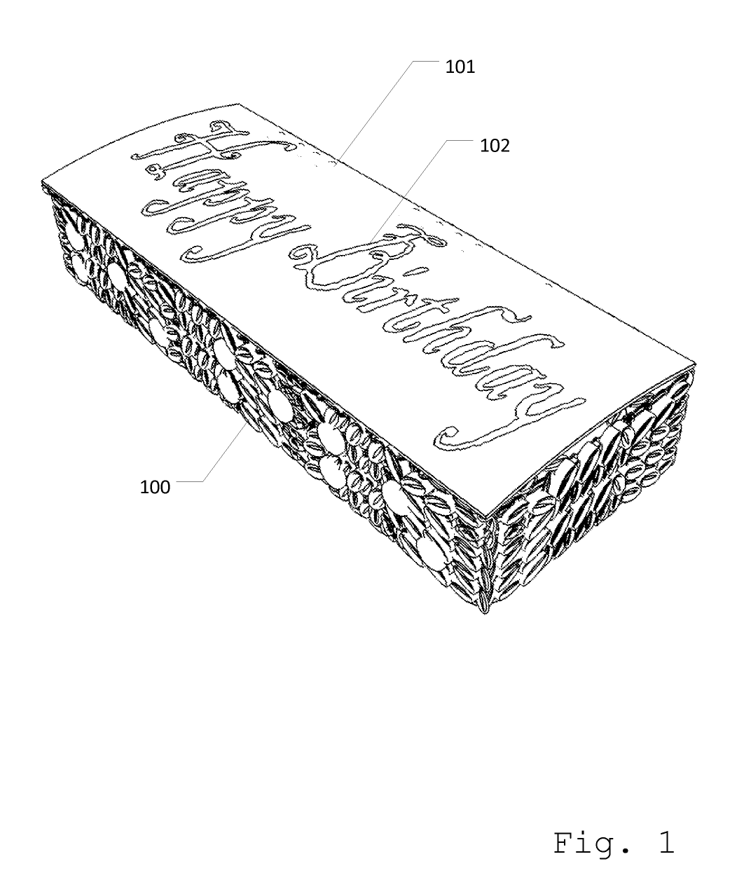

FIG. 1 illustrates an edible sheet 101 printed with edible ink 102 placed on a food item 100. Food item 100, for purposes of this disclosure, is limited to a cereal, or a bar-type food such as a cereal bar, granola bars or wafer sticks. Food item 100 specifically excludes cakes. Food item 100 can be any type of food item bars, baked goodies and treats. Food item 100 can be used as a base wherein edible sheet 101 can be attached.

Edible sheet 101 can be a thin piece of edible material or frostings that can be used as a base for printing any text or images. Edible sheet 101 can be made from different edible ingredients which can include but are not limited to wafer paper, sugar, cornstarch, and/or frostings. Ink 102 is an edible and specially manufactured to be printed onto sheet by a commercially available standard printer. Ink 102 can be made from natural and synthetic sources such as food colorings and dyes. Further, various images and text design can be produced on edible sheet 101 through printing process using a compatible printer and compatible ink 102 for edible sheet 101.

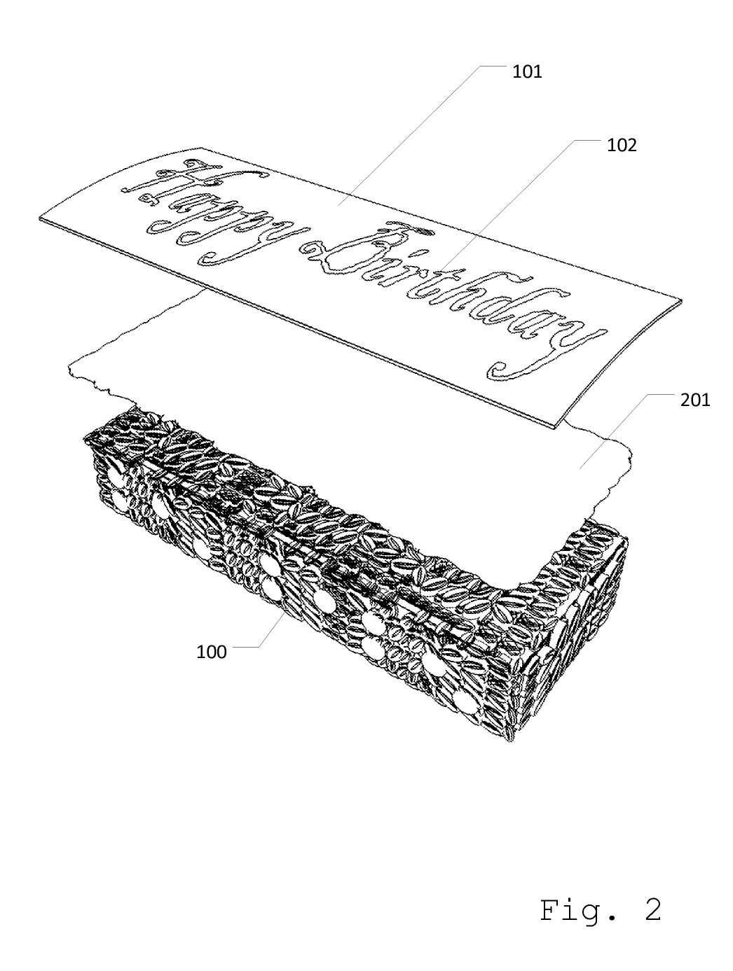

FIG. 2 illustrates how edible sheet 101 can be attached on a food item 100 through an edible adhesive 201. Food item 100 can comprise one or more surfaces 103. Surfaces 103 can be a flat base wherein edible sheet 101 can be placed upon. In one embodiment, food item 100 can comprise of only one surface 103. This embodiment can usually be seen in food item 100 having a cylindrical structure such as wafer and pretzel sticks. In another embodiment, food item 100 can comprise two or more surface 103, which can be apparent with food item 100 that has a bar form. Food item 100 that has a bar form include but are not limited to cereal bar, granola bar, crispy rice bars, biscuits, crackers and/or breakfast cereals bars. Moreover, food item bars can consist of different mixtures such as nuts, honey, dried fruits, flax seeds, and crispy rice. Food item bars can be baked until crisp, which makes the mixture maintain its loose appearance and consistency. Furthermore, food item bar can be compressed in shape and can have a chewy consistency.

Edible adhesive 201 can be gelatinous or paste-like substance made from natural and edible ingredients that can be capable of attaching edible sheet 101 on a rough surface. In one embodiment, edible adhesive 201 can comprise a textured coating made of food substances such as whole grains or starch. Furthermore, edible adhesive 201 can have a gel like texture as to be able to fill in the loose surfaces or gaps within the surfaces of food item 100. In such embodiment, edible adhesive 201 can fill in the spaces of food item 100 thus creating portions of flat surface wherein edible sheet 101 can be applied. Further, edible adhesive 201 can be used to fill in the gaps within surfaces 103. As such one or more sheets 101 can be used to cover surfaces 103. In one embodiment, edible adhesive can comprise honey, sugar water, and/or frosting.

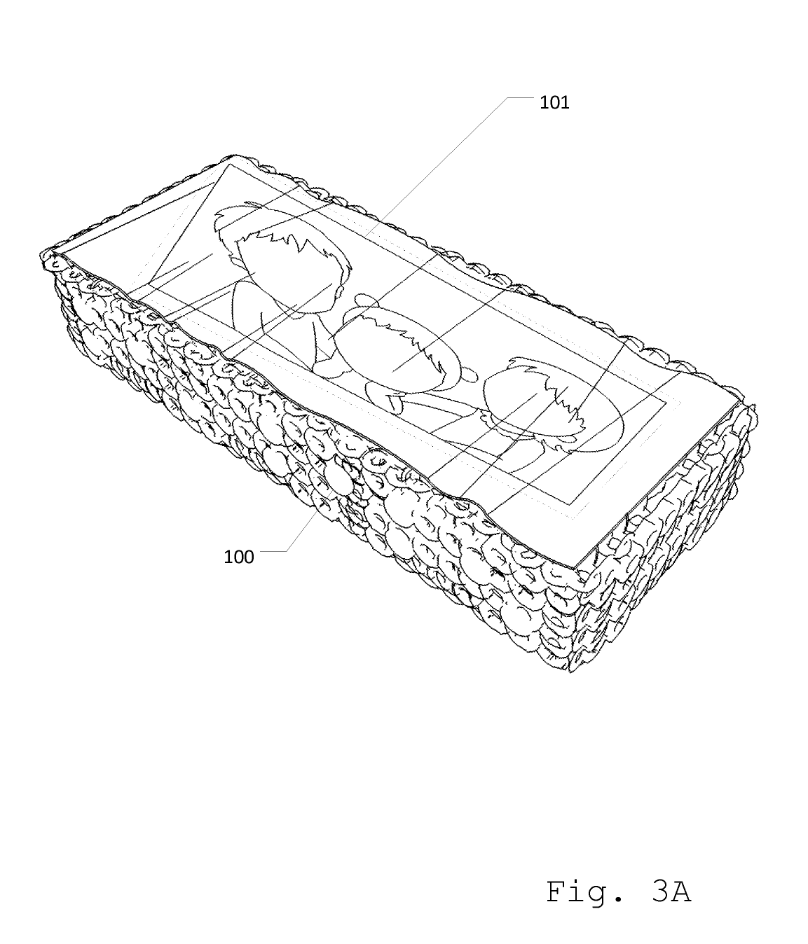

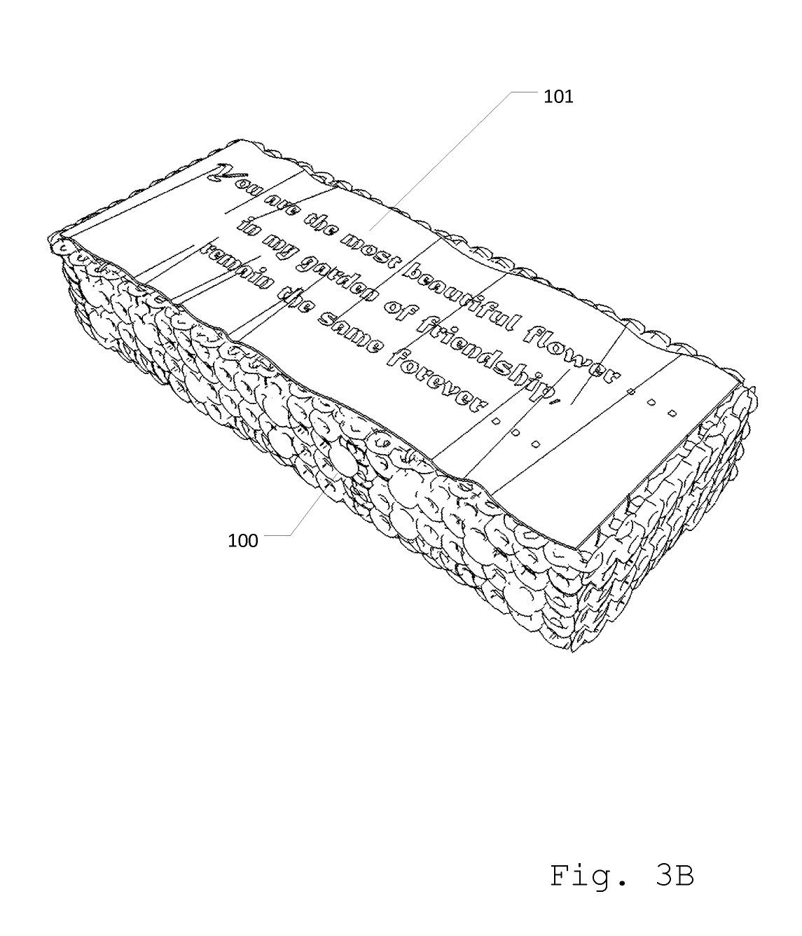

FIG. 3A illustrates food item 100 with pictures printed. In this embodiment, printings on edible sheet 101 can include high quality images and photos. As such, food item 100 can be used to personalize give away and gift items during special occasion such as birthdays, baptisms, and weddings.

FIG. 3B illustrates food item 100 with small text printed. In this embodiment, food item 100 can be customized for marketing and advertising purposes. As such, edible sheet 101 attached on food item 100 can be printed with business card information, logos, and/or other printed advertisement.

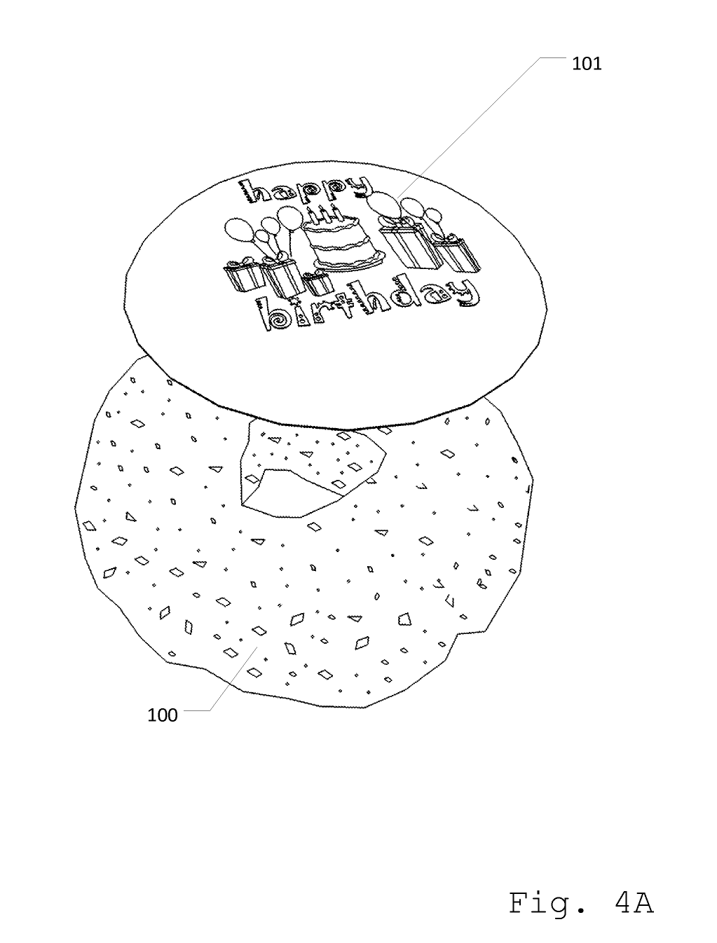

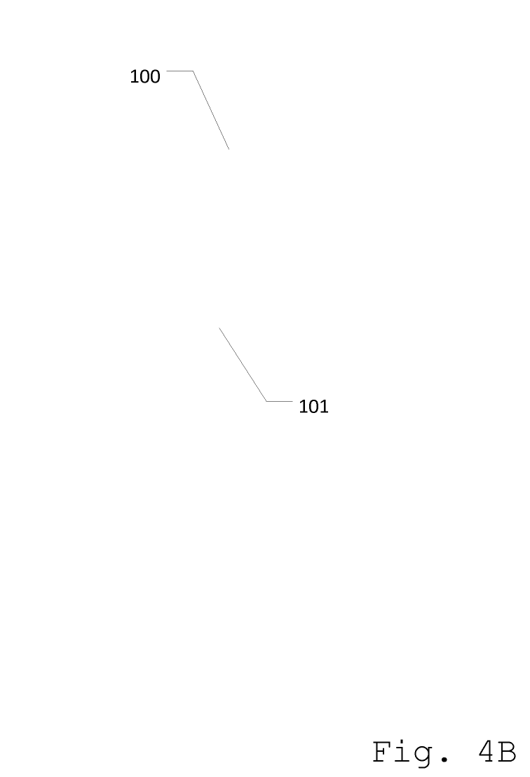

FIG. 4A illustrates an embodiment of food item 100. In this embodiment, food item 100 can be a breakfast cereal. A breakfast cereal can be a flakes, or in a loop form. This embodiment shows that small food can also be used as a base for attaching edible sheet 101. In a preferred embodiment, edible sheet 101 can be printed on, then cut, and the cut portions of edible sheet 101 attached to food item with edible adhesive 201

FIG. 4B illustrates another embodiment of food item 100. In this embodiment, food item 100 can be a wafer stick. In such embodiment, small text such as greetings, quotations, bible verses, or sayings can be printed on edible sheet 101. Moreover, this embodiment shows that surface 103 of food item 100 can be completely covered with sheet 101.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for printing on a food item comprising
a food item;
one or more edible sheet, said edible sheet printable with a design; and
an edible adhesive that attaches said edible sheets onto said food item.

2. The system of claim 1 wherein said food item is a wafer stick.

3. The system of claim 1 wherein said food item is a pretzel stick.

4. The system of claim 1 wherein said food item is a granola bar.

5. The system of claim 1 wherein said food item is a cereal bar.

6. The system of claim 1 wherein said food item is a crispy rice bar.

7. The system of claim 1 wherein said food item is a breakfast cereal.

8. The system of claim 1 wherein said design comprises a picture.

9. The system of claim 1 wherein said design comprises text.

10. The system of claim 1 wherein said design comprises an advertisement.

11. The system of claim 1 wherein said edible sheet comprises wafer paper.

12. The system of claim 1 wherein said edible sheet comprises sugar.

13. The system of claim 1 wherein said edible sheet comprises cornstarch.

14. The system of claim 1 wherein said edible sheet comprises frosting.

15. A method for placing a print on a food item comprising
printing a design on a surface of an edible sheet; and
connecting edible sheet to one or more surfaces of a food item using an edible adhesive.

16. The method of claim 15 wherein said food item is a granola bar.

17. The method of claim 15 wherein said food item is a cereal bar.

18. The method of claim 15 wherein said food item is a breakfast cereal.

19. The system of claim 1 wherein said food item is a crispy rice bar.

20. The system of claim 1 wherein said food item is a wafer stick.
